(19) United States
(12) Patent Application Publication
(10) Pub. No.: US 2013/0019876 A1
(43) Pub. Date: Jan. 24, 2013

(54) Breast Treatment Device

(71) Applicants: Nicholas Zacharopoulos, Congers, NY (US); Andrew J. Tamas, Congers, NY (US); Milan Markovic, Congers, NY (US)

(72) Inventors: Nicholas Zacharopoulos, Congers, NY (US); Andrew J. Tamas, Congers, NY (US); Milan Markovic, Congers, NY (US)

(21) Appl. No.: 13/555,921

(22) Filed: Jul. 23, 2012

Related U.S. Application Data
(60) Provisional application No. 61/510,384, filed on Jul. 21, 2011.

(51) Int. Cl. A61G 15/12

(52) U.S. Cl. 128/845

(57) ABSTRACT

A breast treatment device including components to allow the positioning of a patient for medical treatment and ensuring the proper positioning of the patient's other breast to avoid its inadvertent treatment. A breast support is used to grip and securely hold the non-treatment breast in position on a sternal bridge which is easily positioned as warranted for a particular patient. The sternal bridge is positioned by moving support arms. The device includes cushions/supports for the patient's head, sternum, forearm, elbow, upper arm and hand.

### BACKGROUND

The current approach in prone breast radiation treatments for breast cancer involves laying the patient in the prone position and allowing the treated breast to hang within an opening in the system. The non-treated breast is maintained out of the field with a breast support.

This approach has many problems:
1. Discomfort in the non-treated breast. In order to keep the non-treated breast out of the field (therefore reducing the radiation delivered to it), it must not be allowed to hang through an opening in the board (similar to the treated breast). Typically the non-treated breast is compressed under the patient's weight on a support. This can be extremely uncomfortable for the patient.
2. Difficulty visualizing the radiation field edge. It is critical to the accuracy of the treatment that the patient be set up in the correct position relative to the radiation beam delivery system. A standard method for setting up the patient is to use visible markers within the room such as optical lasers or a light projected onto the patient's skin simulating the radiation field. In the standard prone position, it is extremely difficult to see the light field projection onto the patient from the non-treated side of the patient. This is due to the fact that the non-treated breast support blocks the light field.
3. Difficulty setting up the patient. It is often very desirable to slightly tilt the patient a few degrees off the pure prone position. Doing this with standard prone breast boards is difficult and usually involves the placement of additional pillows or cushions beneath one side of the patient. Using pillows or cushions does not provide a robust or reproducible method required for such treatments. Slight rotational errors are addressed by adding or subtracting pillows or by physically assisting the patient to rotate their torso and thorax into the correct position. Both methods tend to result in less than desirable results.

### SUMMARY

A device is disclosed which enables the proper positioning of a patient's breast for medical treatment. The device places the patient in a stable semi-decubitus position with the non-treated breast pulled up and out of the field. And a method for positioning a patient using this device is also disclosed.

The device and method disclosed accomplishes the following:
1. Mechanized Angular Adjustment. The patient “roll” (rotation about head to foot axis) of the patient can be fine-tune adjusted without having to physically roll the patient on the system. This is handled via the mechanism sternum bridge (or with any other mechanism that allow the patient to be adjusted). This mechanism can be performed either manually as shown in his document or with motors or hydraulic components.
2. Clear visibility of the Breast from both sides. The disclosed device and method is the first of its kind not to rely on a breast plate to compress the non-treated breast. This is accomplished by the sternum bridge. The disclosed device only supports the patient along the sternum in the treatment area, which is entirely unique. All other systems support the patient everywhere except the treated breast (by having the patient lie down on a flat board that has a cutaway on the side of the treated breast)
3. Semi decubitus setup. All other prone breast boards have the patient line in the prone position. The disclosed device uses a semi-decubitus position where the patient is laying on their side more than their anterior. This allows the non-treated breast to be pulled up and out of the field.
4. Non-compression of the opposite breast. Since the patient is not required to be in a perfect prone position, the opposite breast is already out of the treatment fields, and can be supported with a comfortable breast support.

### BRIEF DESCRIPTION OF DRAWINGS

FIG. 1 depicts the breast treatment device set up on a table.

FIG. 2 depicts the three main sections of the breast treatment device.

FIG. 3 depicts the front section of the breast treatment device.

FIG. 4 depicts the middle section of the breast treatment device.

FIG. 5 depicts the blown-up view of a section of FIG. 4.

FIG. 6 depicts the back section of the breast treatment device.

FIG. 7 depicts the elbow cushion ready to be placed on front section.

FIG. 8 depicts the upper arm section ready to be placed on front section.

FIG. 9 depicts the hinges and underside of the front section.

FIG. 10 depicts the Table Top.

FIG. 11 depicts the breast support.

### PARTS LIST

1—Front section
2—Middle section
3—Rear section
4—Base
5—Adjustment Nut
6—Lead Screw
7—Support pivot
8—Hinges
9—Locking Pin, arm support
10—Locking Pin, elbow support
11—Hand Grip
12—Mounting Plate
13—Forearm cushion/support
14—Elbow Cushion/support
15—Arm support rails
16—Under arm cushion/support
17—Handle
18—Interface Pin
19—Adjustment hex nut
20—Breast support female buckle
21—Table indexing pin
22—Pinch-point guard
23—Head cushion/support
24—Superior side support
25—Guide pin
26—Support Arm
27—Ball joint
28—Release pin
29—Sternal bridge
30—Bracket support
31—Spindle
32—Superior-Inferior Scale
33—Sliding ball joint
34—Inferior side support
35—Bracket support base
36—Spindle holder
37—Support base
38—Vertical scale
39—Couch top
40—Pedestal
41—Breast support male buckle
42—Breast support snap
43—Breast support elastic band
44—Breast support non-elastic band
45—Breast support
46—Body cushion
47—Breast support snap

### DETAILED DESCRIPTION

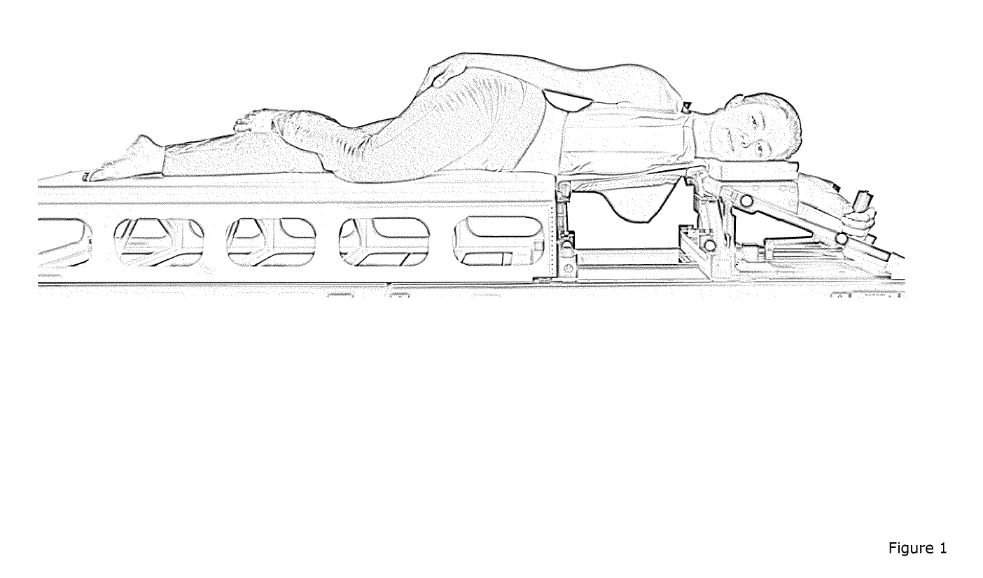

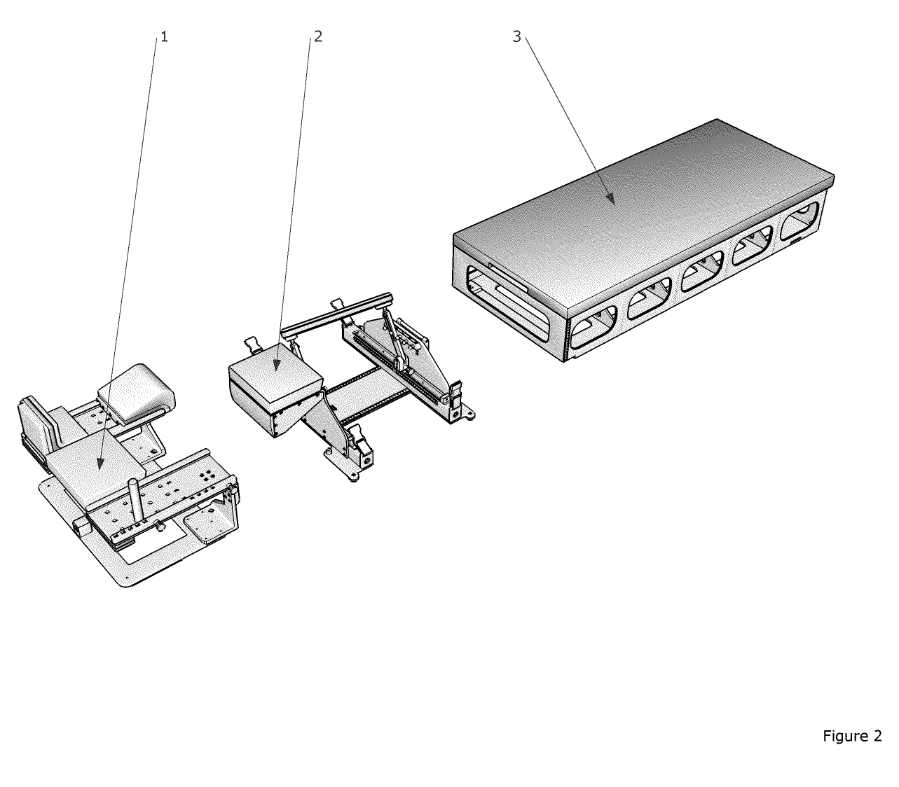

In one embodiment the breast treatment device includes three main sections set up on a treatment table (FIGS. 1 and 2). The front section used to support the patients arm in a comfortable position. The middle section provides support for the patient sternum and head. The rear section provides support for the patient's abdomen and lower torso. The 3 sections are mounted on a top and a pedestal such as a LINAC couch top and pedestal.

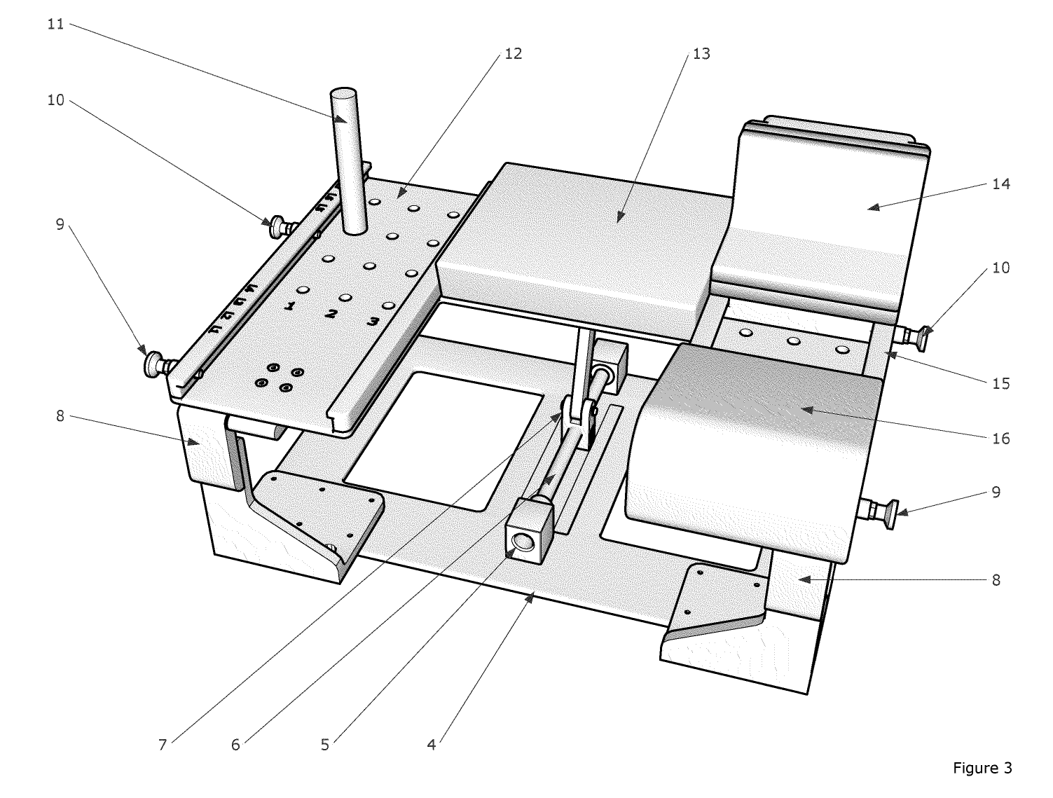

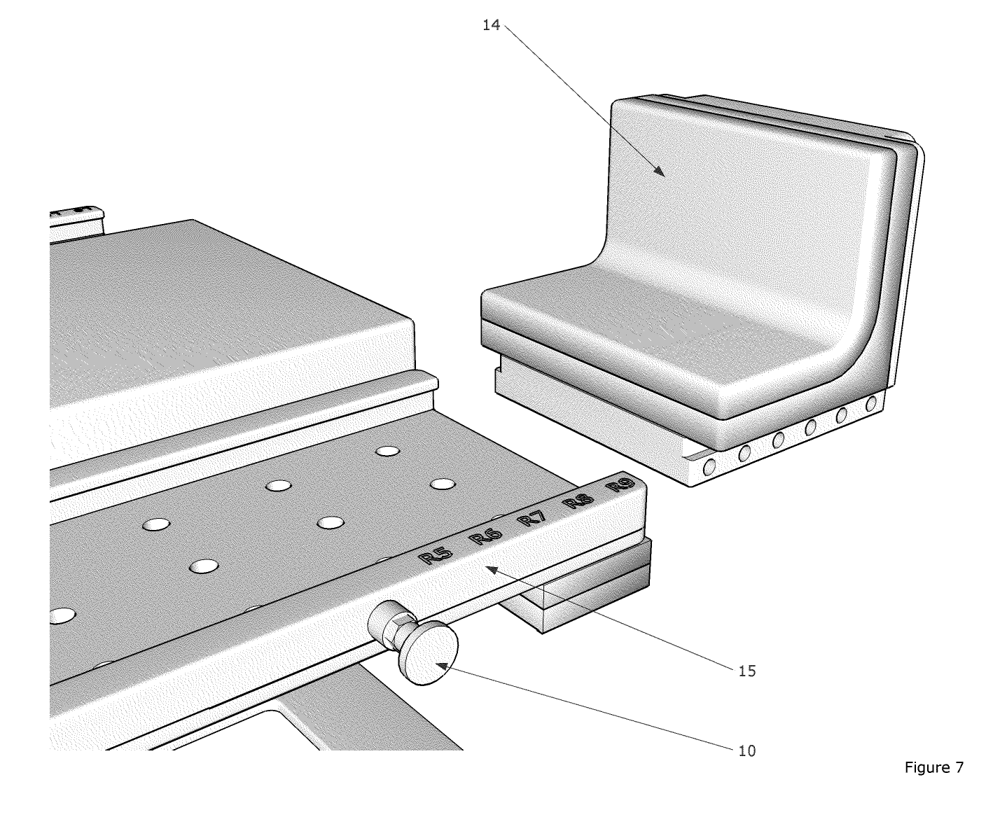

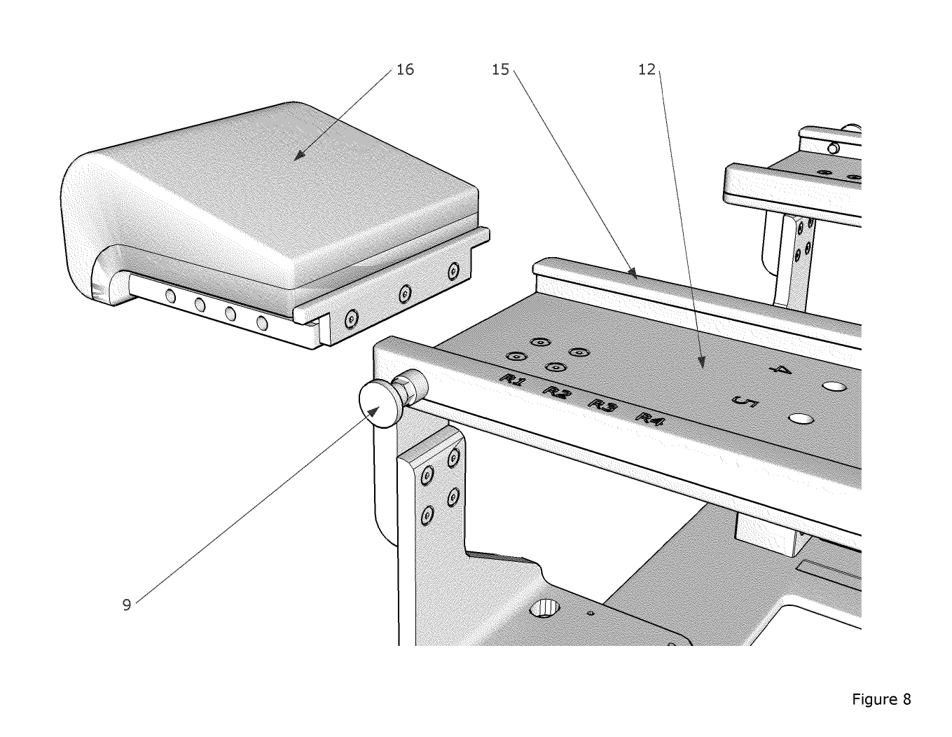

The front section (1) (FIGS. 3, 7, 8, 9) includes an under-arm cushion (16), a hand grip (11), an elbow cushion (14) and a forearm cushion (13) assembled on a mounting plate (12). The under-arm and elbow cushions are mounted on rails (15) which are secured to the mounting plate (7). The positions of the under-arm and elbow cushions are adjustable along the rails (15). FIGS. 3, 7, & 8 show one means of adjusting the position utilizing pins (9) and (10) inserted into a selected hole along the rails. The cushions can be inserted along the rails (15) on either side of the device to facilitate treatment of the right or left breast.

A hand grip (11) and cushions (14 & 16) are secured to opposite sides of the mounting plate (12) and designed to be positioned on the mounting plate (12) to accommodate a particular patient. The hand grip (11), the elbow cushion (14), and the under-arm support (16) are also designed to allow swapping locations on the mounting plate (12) to facilitate treatment of the right or left breast. FIG. 3 shows one means to facilitate the positioning of the hand grip (11), the elbow cushion (14), and the under-arm support (16). The handgrip (11) is secured by insertion into one of the holes on the plate (12) within a grid of docking positions. The elbow cushion (14) and under-arm cushion (16) are secured with the rails (15). Both the elbow cushion (14) and the under-arm support (16) are designed to slide on rails (15) on the mounting plate (12). One method to secure them in a particular position on the mounting plate is to use pins (9) and (13) inserted through holes on the rails (15).

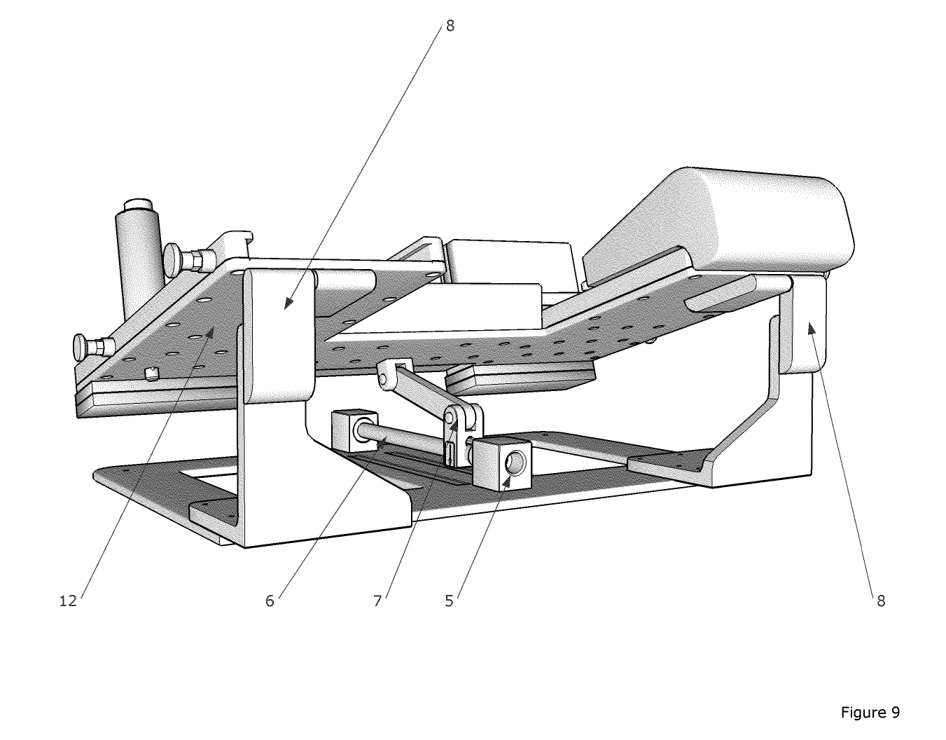

An adjustment nut (5) can be turned to move the support pivot (7) along the lead screw (6). When this happens, the entire mounting plate (12) will rotate about the hinges (8). FIG. 9 shows mounting plate at a lower angle as compared to FIG. 3. Since the entire support (12) can rotate downward as shown in FIG. 9, there is the possibility that the patient might have a finger (or some body part) below the metal shelf underneath the head support (23), which could get pinched or squeezed, once the support was rotated back upward. The pinch-point guard (22) keeps body parts out of this area.

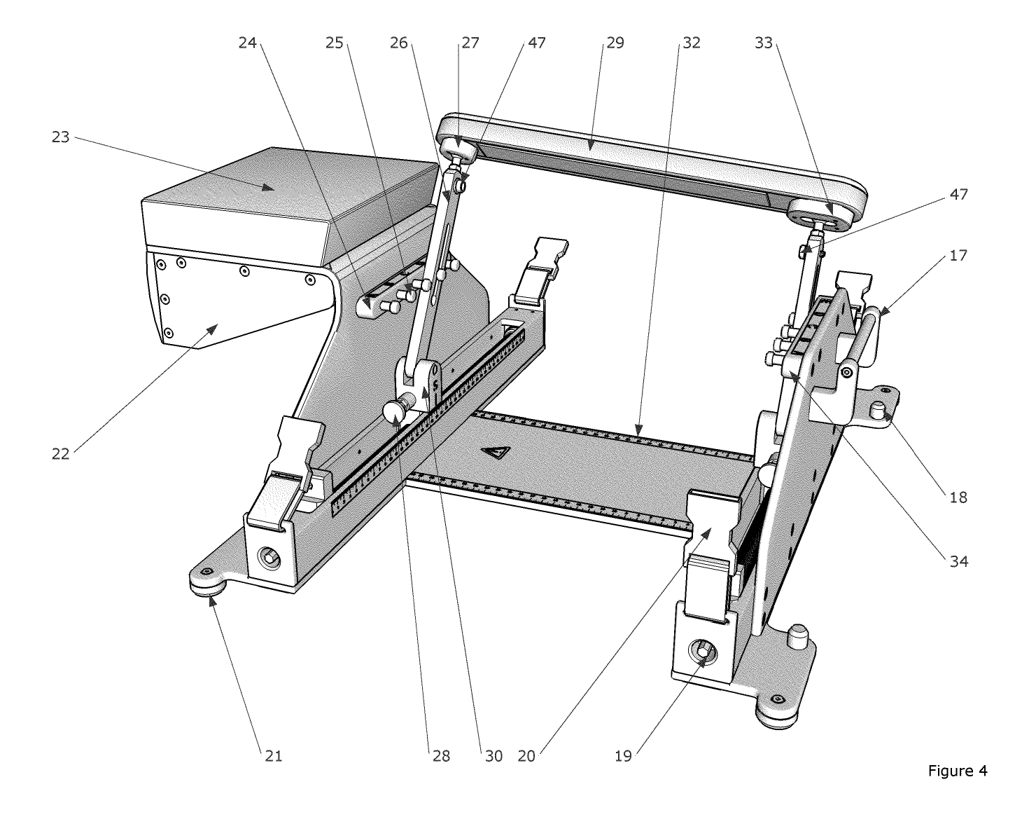

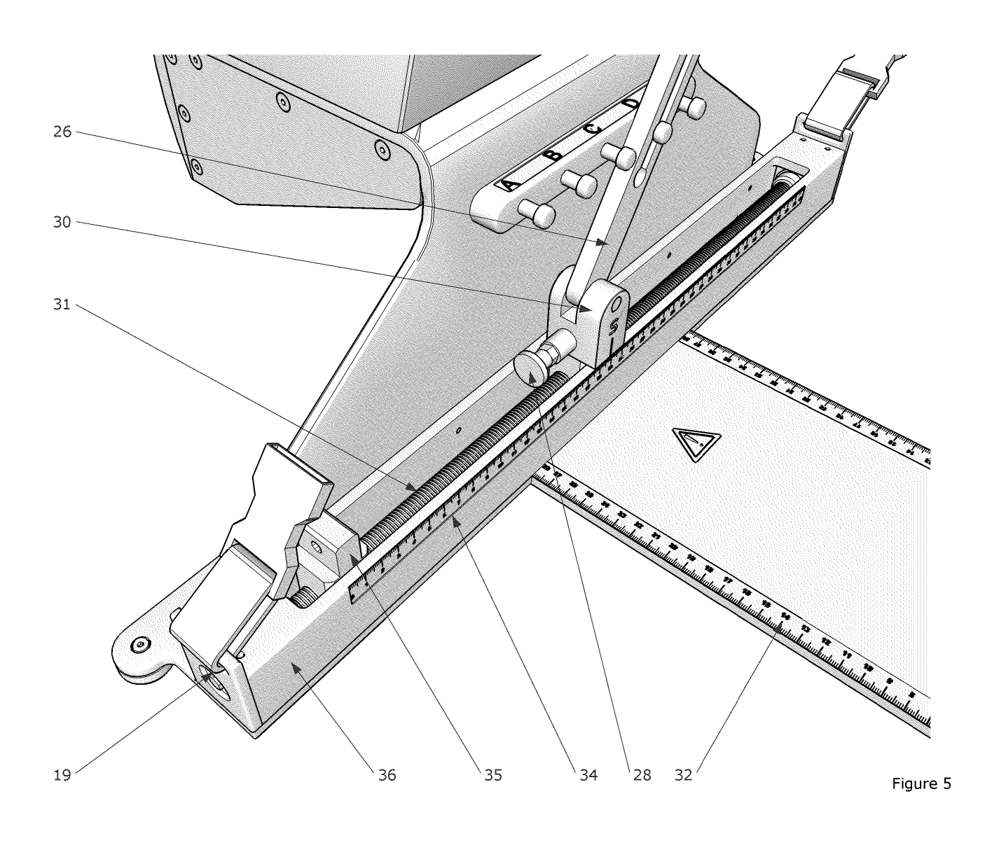

A possible configuration for the middle section of the breast treatment devise is shown on FIGS. 4 and 5. The middle section provides a support structure for the head and sternum of the patient. The middle section (2) includes a position adjustable sternal bridge (29) and a head cushion (23).

FIGS. 4 and 5 show one method to provide for adjustment of the sternal bridge position. The sternal bridge (29) is connected to support arms (26) by means of a ball joint (27) on one end of sternal bridge (29) and a sliding ball joint (33) on an opposite end of the sternal bridge (29). The support arms (26) are supported and held in a selected position in three locations on the support arms (26).

The first support location is at one of its ends where it is attached to the ball joint (27) for one of the support arms (26), and the sliding ball joint (33) for the other support arm (26). The support arms are attached via a pin (25) to the superior side support (24) for one support arm (26) and the inferior side support (34) for the other support arm (26). The second location is at the support arm's other end where it is attached to the bracket support (30). The third support location is at a mid-section of the support arm (26) where a guide pins (25) is inserted through the support arm (26) into the superior (24) or inferior (34) side support (24).

The bracket support (30) is mounted on a spindle (31). The spindle (31) is mounted in a spindle holder (36). A hex head (19) is provided on the ends of the spindle (31) to allow rotation of the spindle (31) to move the position of the support arm (26) causing movement of the position of the sternal bridge (29).

Indexing cams (21) are use to to allow positioning of the middle section (2). A scale (34) mounted on the side of a spindle holder (36) indicated position by a pointer on the bracket support (30). A Superior-Inferior Scale (32) is used to move the treatment table to the correct position within the coordinate system of the radiation field typically by using room lasers. After the first setup is complete and the therapist confirms everything is setup correctly, the therapist will document where the room lasers are aligning with this scale. They will then ensure that all subsequent treatments have the room lasers at the same position. Adjustments are made by moving the pedestal (40) such as a LINAC pedestal.

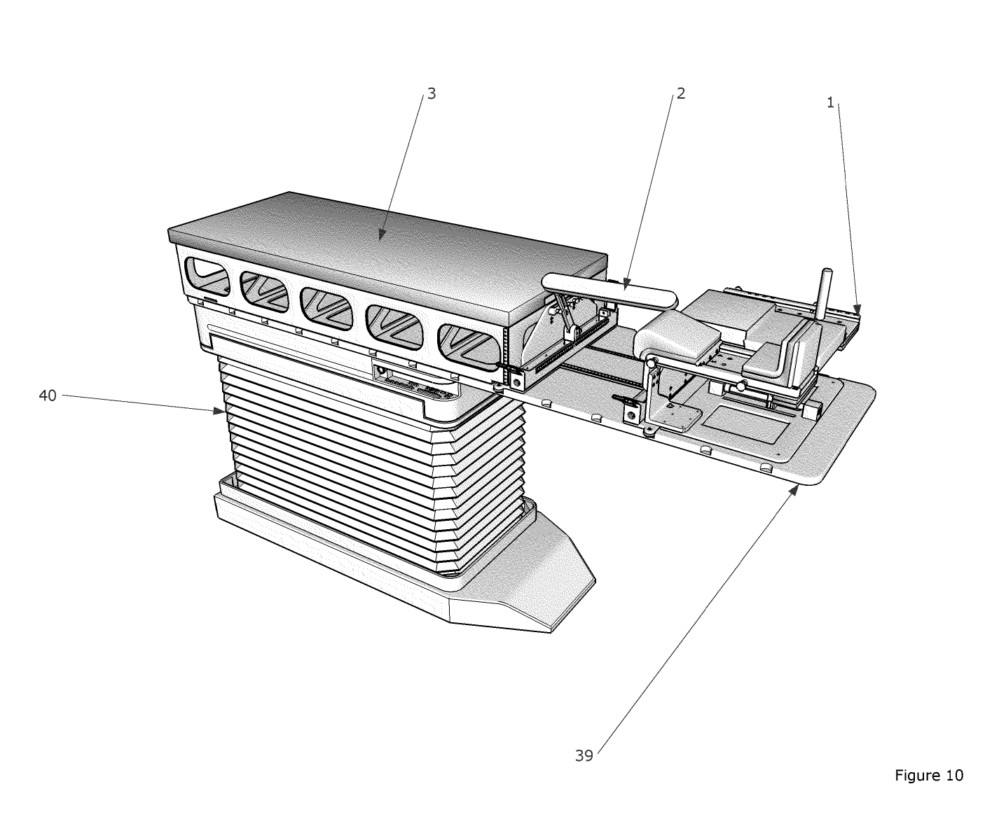

The handle (17) is used to transport the middle section to the treatment table. The two interface pins (18) are used to interface the middle section (2) to the rear section (3). There are two corresponding holes in the rear section (3) that accept the interface pins (18). The breast support buckle (20) is attaches to the breast support FIG. 10 as seen in FIG. 1.

The table indexing pins (21) are used to position the middle section (2) into the existing treatment table which has corresponding holes to accept the indexing pins (21). The pinch-point guard (22) is used to make sure that the patient cannot injure themselves while the mounting plate (12) angle is being adjusted. The release pin (28) is used to release the support arm (26) from the bracket support (30) in order to change which guide pin (25) is being used to fix the position of the support arm (26). The choice of which guide pin (25) to use will determine the left-to-right position of the sternal bridge (29) to account for different size patients.

As shown on FIG. 5 there are two bracket support bases (35): one is shown and one not visible beneath the bracket support (30). The additional bracket support bases are used when the system needs to be converted from a left-sided-breast treatment to a right-sided-breast treatment. This additional bracket support base (35) is only present for convenience, so that the user does not have to turn the lead screw (36) in order to move the bracket support along the entire length of the lead screw (36).

In order to convert the system from left to right sided treatment, the release pin (28) is pulled to detach the bracket support (30) from the bracket support base (35) beneath it. While keeping the release pin (28) in a retracted position, the bracket support (30) is repositioned over the bracket support base (35) allowing the spring loaded release pin (28) to re-engage, locking the bracket support (30) to the bracket support base (35).

The release pin (28) is used to release the support arm (26) from the bracket support (30) in order to change which guide pin (25) is being used to fix the position of the support arm (26). The choice of which guide pin (25) to use will determine the left-to-right position of the sternal bridge (29) to account for different size patients.

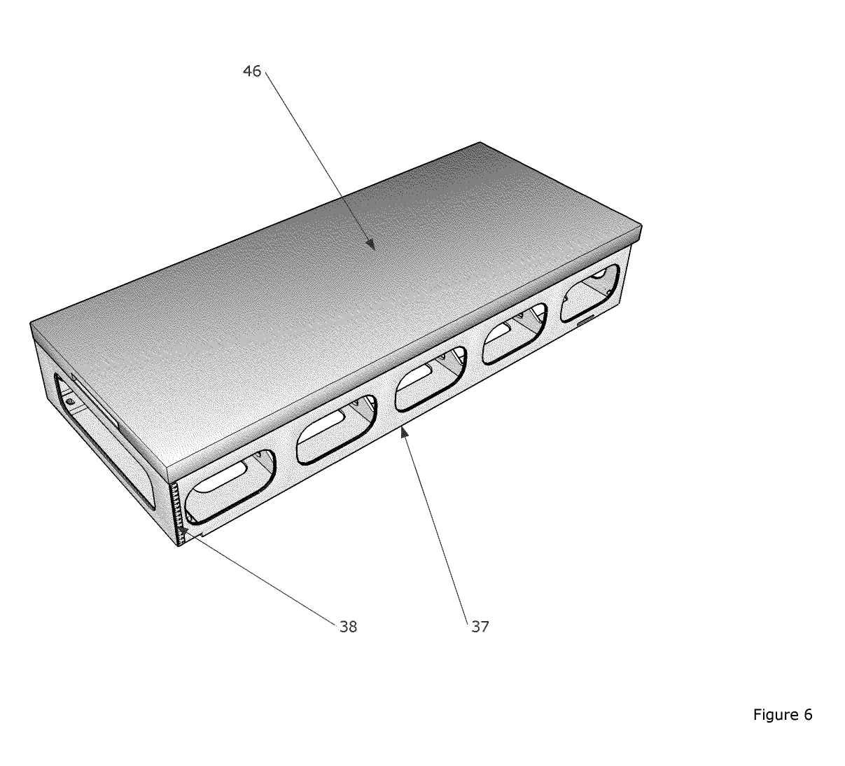

The rear section (3) as shown on FIG. 6 includes a support base (37), a body cushion (36) and a vertical scale (38) which helps the user identify the proper height of the system within the treatment beam. The vertical scale (38) is used in a similar manner as superior-inferior scale (32). It is used to position the couch top in the correct location within the coordinate system of the treatment field by use of room lasers.

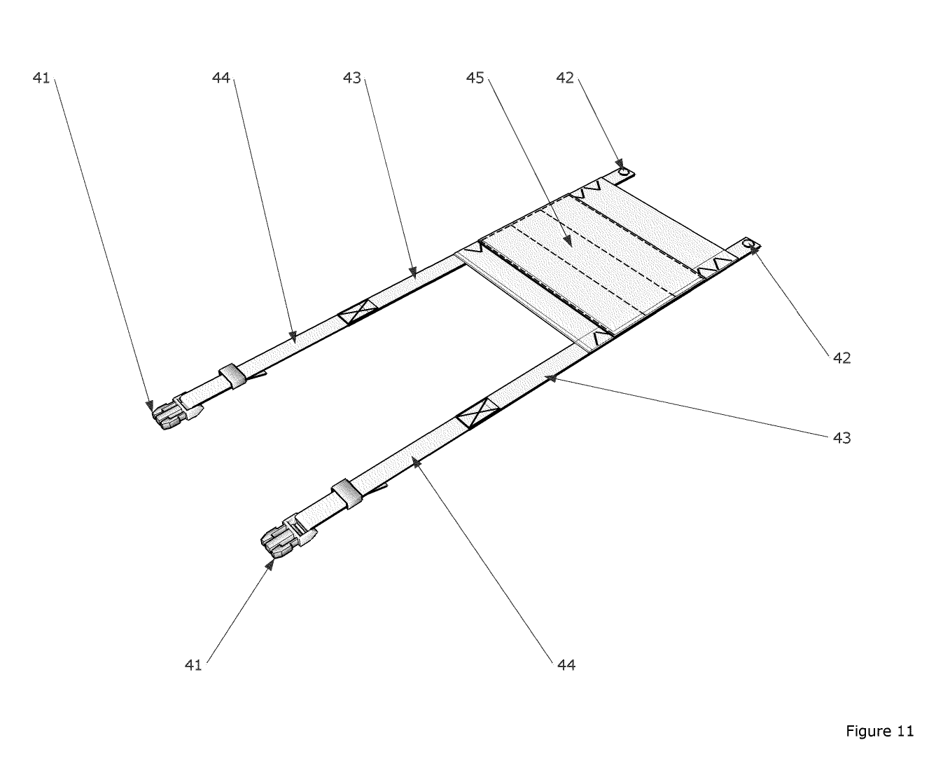

A breast support (FIG. 11) is used to support the non-treated breast out of the radiation field. The breast support is attached to the device by connecting the breast support male buckle (41) to the breast support female buckle (20) on the middle section (2). The breast support then wraps around and under the patient (as shown in FIG. 1) to finally connect the breast support snaps (42) to the sternal bridge (29) breast support snaps (47). The tension of the breast support can be adjusted to accommodate different size patients by adjusting the length of the non-elastic band (44) that passes through the breast support male buckle (41).

One method for using this device is as follows:
1. The patient will first sit onto the device.
2. The therapist will assist the patient to place their treatment side elbow into the cushioned support as shown. The patient and the therapist will then guide the sternal bridge bar into the patient's sternum. The therapist will also position the non-treatment side arm to be positioned over the hips.
3. The opposing breast will be wrapped in a breast support.
4. The therapist will guide the elastic straps of the breast support over the patient's shoulder and mid-section.
5. The therapist will pull the elastic straps of the breast support over the patient.
6. The therapist will snap the straps of the breast support into the breast support buckle (20).

The therapist can adjust the tilt and height of the sternal bridge by turning either of the hex screws as shown below. The adjustment of the sternal bridge will lift, lower, or pitch the patient's chest wall. This adjustment will be performed with the goal of aligning the treatment room lasers to marks placed on the patient's skin, or by aligning the projection of the treatment light field onto the treatment field edge delineated on the patient's skin.

There are numerous components and configurations which are possible to create the desired positions of a patient for breast treatment consistent with the embodiment disclosed above. Some examples of alternatives are:
use of motor, hydraulics or pneumatics to move the position of the support arm;
rotation of the bridge via direct connection to a motor or hydraulic/pneumatic positioner; or indirectly through use of gearing;
grouping of the required components into more or less than the 3 sections disclosed;
using sensors to accurately determine positions of components and patient;
remotely controlling the position of components and patients.

The above illustrates various concepts, structures and techniques which are the subject of this patent. It will now become apparent to those of ordinary skill in the art that other embodiments incorporating these concepts, structures and techniques may be used. Accordingly, it is submitted that the scope of the patent should not be limited to the described embodiments but rather should be limited only by the spirit and scope of the following claims. For example the components disclosed can be configured as one section or other number of sections and designed to be mounted on different appropriate pedestals.

We claim:

1. A breast treatment device comprising:
a breast support device designed to secure the breast which is not being treated;
a sternal bridge with two ends each of is connected to a support arm;
a head support;
an upper arm support;
an elbow support;
a forearm support; and
a hand grip.

2. A breast treatment device according to claim 1 wherein the breast treatment device is designed for mounting on a couch top mounted a pedestal.

3. A breast treatment device according to claim 1 in which the breast treatment device is designed to allow the position of the upper arm support, the elbow support, the forearm support, and the hand grip to be adjusted as warranted for a particular patient.

4. A breast treatment device according to claim 3 in which the position of the upper arm support, the elbow support, the forearm support, and the hand grip to be adjusted from a remote location as warranted for a particular patient.

5. A breast treatment device according to claim 1 wherein one end of one support arm is connected to the sternal bridge utilizing a ball joint located at one end of the sternal bridge; and one end of a second support arm is connected to a second end of the sternal bridge utilizing a sliding ball joint.

6. A breast treatment device according to claim 4 wherein the second end of each support arm is attached to a bracket support and at a point in between the two ends of each support arm the support arm is attached to a side support with the location for this attachment being determined by the body of a patient.

7. A breast treatment device according to claim 5 wherein the support bracket is mounted on a spindle to allow movement of the support arm which causes movement of the sternal bridge.

8. A breast treatment device according to claim 5 in which the breast treatment device is designed to allow the position of the upper arm support, the elbow support, the forearm support, and the hand grip to be adjusted as warranted for a particular patient.

9. A breast treatment device according to claim 6 in which each of two spindle holders is attached to the side support associated with the support arm which is controlled by the spindle in that spindle holder.

10. A breast treatment device according to claim 6 in which the

[symbol]

11. A breast treatment device according to claim 3 wherein one end of the breast support device is designed for attachment to the sternal bridge and a second end of the breast support device is designed for attachment to at least one spindle holder.

12. A breast treatment device according to claim 6 in which each of two spindle holders is attached to the side support associated with the support arm which is controlled by the spindle in that spindle holder.

13. A breast treatment device according to claim 12 wherein the upper arm support, the elbow support, the forearm support, and the hand grip are mounted a mounting plate which is attached to a base utilizing hinges and a support pivot wherein the position of the support pivot and thus the mounting plate is controlled by movement of a lead screw mounted on the base.

14. A breast treatment device according to claim 12 wherein the position of the support pivot and each of the support arms are controllable remotely.

15. A breast treatment device according to claim 12 wherein the breast treatment device is designed for mounting on a couch top mounted a pedestal.

16. A method for securely positioning a patient for medical treatment of a breast comprising:
selecting a device which allows the use of a breast support to secure the breast which is not to be medically treated and which also allows the positioning and support of a patient's head, upper arm, elbow, forearm and hand; and the device further comprises a sternal bridge;
mounting the device on a couch top and pedestal;
seating the patient on the device and position the patient's head, elbow, upper arm, forearm and hand to an appropriate support for each on the device;
positioning the sternal bridge into the sternum;
wrapping the breast which is not being treated with the breast support and connecting the breast support to the device.

17. A method for securely positioning a patient for medical treatment of a breast further comprising adjusting the tilt and height of the sternal bridge as warranted.
